(19) United States
(12) Patent Application Publication
(10) Pub. No.: US 2005/0216299 A1
(43) Pub. Date: Sep. 29, 2005

(54) Methods and systems for acquiring rights to content for transmission at an event

(76) Inventors: Tazwell L. Anderson JR., Atlanta, GA (US); Geoffrey L. Anderson, Atlanta, GA (US); Mark A. Wood, Decatur, GA (US)

Correspondence Address: Dean D. Small;Armstrong Teasdale LLP, Suite 2600, One Metropolitan Square, St. Louis, MO, 63102, US

(21) Appl. No.: 11/077,656

(22) Filed: Mar. 11, 2005

Related U.S. Application Data
(60) Provisional application No. 60/552,928, filed on Mar. 12, 2004.

(51) Int. Cl. G06F 17/60

(52) U.S. Cl. 705/1

(57) ABSTRACT

A method is provided for acquiring rights to content for transmission at an event. The method comprises identifying at least one of sources, carriers and owners of content for transmission at an event. The sources, carriers and owners include at least one of event content sources, event content carriers, event content owners, non-event content sources, non-event content carriers, non-event content owners, venue owners, event organizers and event participants. The method includes determining access rights to be acquired to transmit the content at the events, and establishing at least one agreement with at least one of the sources, carriers and owners to acquire the access rights to transmit the content at the event. The method may include establishing separate agreements with the sources of the content, the carriers of the content and the owners of the content.

### CROSS REFERENCE TO RELATED APPLICATIONS

This application claims priority to and the benefit of the filing date of U.S. Provisional Application No. 60/552,928, filed on Mar. 12, 2004 and which is hereby incorporated by reference in its entirety.

### BACKGROUND OF THE INVENTION

This invention relates generally to providing video and audio content at an event and, more particularly, to methods and systems for acquiring rights to video and audio content for transmission to a plurality of users at an event.

Video and/or audio signals are generated from a plurality of sources during many events. For example, at a football game or other type of event (e.g., sporting event, automobile race, concert, circus, etc.), television crews usually position cameras and microphones at various locations at that event (e.g., various locations in a stadium or around a racetrack). As another example, different cameras and microphones may be positioned at different locations at an event, such as an automobile race (e.g., camera and microphone positioned at different turns at the racetrack and/or in the crew pit). At these events, the television crews generate audio and video signals defining views and sounds of the event from various perspectives (e.g., end-zone and sideline view of football game or view of second and third turns at a racetrack). Additionally, the sources that generate these signals may be located at the event (e.g., cameras at a stadium) or may be located remote from an event (e.g., television studio transmitting content from another event or transmitting television programming).

One of the video signals and one of the audio signals are usually selected at a television production facility to form a combined audio/video signal. The signal is then modulated and transmitted such that users having a television or viewing a television at an event can receive the signal via the television (e.g., receive an RF signal). The television demodulates the combined signal and displays an image defined by the video signal on a display screen and reproduces the sounds defined by the audio signal via speakers. Therefore, the sights and sounds of an event, such as a sporting event or game, can be viewed and heard via the television. Other event related or non-event related content also may be transmitted in a similar manner.

However, spectators viewing and/or hearing the sights and sounds of, for example, a game via televisions are not usually given the opportunity to select which video and/or audio signals are modulated and transmitted for viewing. Therefore, the spectator is only able to receive the signals modulated and transmitted to the television as selected at the production facility (e.g., selected by a director viewing different views on multiple screens), even though the spectator may prefer to receive other signals that are generated at the game or remote from the game. This may include spectators watching the event at home on a television or spectators viewing a portable television at the event being viewed both live and on the portable television.

Spectators that attend the event may be given more options to view and/or hear the sights and sounds of the event from different perspectives. For example, one or more monitors are sometimes located at one or more locations in the stadium. Each monitor within the stadium receives one of the aforementioned video signals and displays an image defined by the received video signal to the spectators viewing the monitor. However, the monitor does not always display a desirable perspective with respect to each spectator in the stadium, and the monitor is often not located in a convenient location for many of the spectators. Some of the monitors also may have limited access for viewing by specific spectators. In many instances, spectators often must leave their seats (or other locations) in the stadium and go to a location where the spectators, along with other spectators, can view the monitor displaying the desired perspective. The spectators viewing the monitor often do not have control over the image displayed by the monitor.

Thus, spectators at an event are provided limited content and limited flexibility in selecting from that content for viewing and/or listening.

### SUMMARY OF THE INVENTION

A method is provided for acquiring rights to content for transmission at an event. The method comprises identifying at least one of sources, carriers and owners of content for transmission at an event. The sources, carriers and owners include at least one of event content sources, event content carriers, event content owners, non-event content sources, non-event content carriers, non-event content owners, venue owners, event organizers and event participants. The method includes determining access rights to be acquired to transmit the content at the events, and establishing at least one agreement with at least one of the sources, carriers and owners to acquire the access rights to transmit the content at the event. The method may include establishing separate agreements with the sources of the content, the carriers of the content and the owners of the content.

### BRIEF DESCRIPTION OF THE DRAWINGS

FIG. 1 is a block diagram illustrating different sources of content for transmission at an event in accordance with an exemplary embodiment of the present invention.

FIG. 2 is a flowchart of an exemplary process for acquiring rights to transmit the content from the sources shown in FIG. 1 at an event in accordance with an exemplary embodiment of the present invention.

### DETAILED DESCRIPTION OF THE INVENTION

Exemplary embodiments of the present invention provide methods and systems for acquiring rights to provide spectators at an event with a plurality of audio and video event signals from a plurality of sources and from which a spectator may select content from the different sources while at the event. Generally, the various embodiments allow for re-broadcasting of video and audio content and an event, the rights to which being acquired as described herein.

It should be noted that when reference is made herein to audio and/or video event signals, this refers to any audio or video signal generated and/or transmitted to and/or from an event, such as, for example, audio and video signals that provide information, including, but not limited to, real-time and/or prerecorded information, pertaining to an event or other content from different sources. It should also be noted that when reference is made herein to non-event or non-event related audio and/or video signals, this refers to any live, delayed, or archived and recorded audio and/or video signals such as for example, live audio and/or video signals being generated from another event, rebroadcast audio and/or video signals from an another event, any other live or recorded audio/video content, such as, for example, content relating to sporting events, entertainment events (e.g. movies, cartoons, advertisements, statistics and data) and/or other third party content (e.g., news broadcast).

Various embodiments of the present invention provide for acquiring the rights to allow users with, for example, portable devices, and more particularly, wireless portable devices to receive video and audio content from a plurality of sources and to select at the portable wireless device the content that the user desires or needs to access. For example, a user may select from programming from different sources provided on a plurality of selectable channels. Using the various embodiments of the present invention, rights to allow a transmission or broadcast system to transmit/broadcast a plurality of combined audio/video signals at an event for access by a user with a wireless portable device are provided.

In the exemplary embodiments, the methods and systems generally provide for acquiring rights to content to provide spectators at an event with a selection of audio and/or video event signals pertaining to the event and/or other remote events and other non-event related content that may be of interest to the spectators. In particular, a plurality of different audio and/or video event signals are received from various locations and sources (e.g., remote locations, cable TV channels, Satellite TV channels, on-site camera feeds, Satellite or Digital radio, VCR or DVD players). For example, multiple audio event signals may be received from different events being provided via a Satellite Radio, and each audio event signal may define information, such as a play-by-play commentary pertaining to the event occurring at the stadium from which the audio event signal is generated or from another stadium.

In addition to providing a user with live, non-event audio and/or video content from another sporting or entertainment event, other non-event related content can be provided via a plurality of broadcast sources that are connected to the broadcast system at the event. These other broadcast sources (e.g. Cable TV, Satellite TV, Satellite or Digital Radio, Local Broadcast TV or Radio) can be monitored for relevant non-event related content (e.g. news, weather, sports tickers and scores, movies, cartoons, advertisements, statistics and data) and selected for broadcast at a specific event by the broadcast system located at, for example, a stadium.

The various embodiments allow a broadcast system to access and receive audio and/or video event signals from various sources, and communicate such signals to spectators at the stadium serviced by the broadcast system. The communication of such signals may be wireless and/or non-wireless. For example, the broadcast system may modulate each of the audio and/or video event signals on a carrier signal of a different frequency and wirelessly transmit the modulated signals to the stadium spectators. The stadium spectators may be provided with portable receiver units that demodulate and filter the audio and/or video event signals transmitted by the broadcast system. Specifically, using a receiver unit, a spectator may select one or more of the audio and/or video event signals received by the receiver unit, and the receiver unit may filter out all of the other audio and/or video event signals, thereby recovering the selected audio and/or video event signal or signals. The recovered audio and/or video event signal or signals may then be converted into sound via one or more speakers of the receiver unit or images via a display of the receiver unit.

The various embodiments provide for acquiring rights to allow for transmitting via wireless frequencies various combinations of video and audio content (e.g., rights to re-broadcast) at one or more events that may be occurring at different times or simultaneously. The content includes, but is not limited to, event content, non-event or non-event related content received from a plurality of sources, both at the event and remote from the event. The content may be transmitted to the event via any suitable means (e.g., satellite, cable, etc.). This content is then re-broadcast, for example, wirelessly at the event for viewing and/or listening.

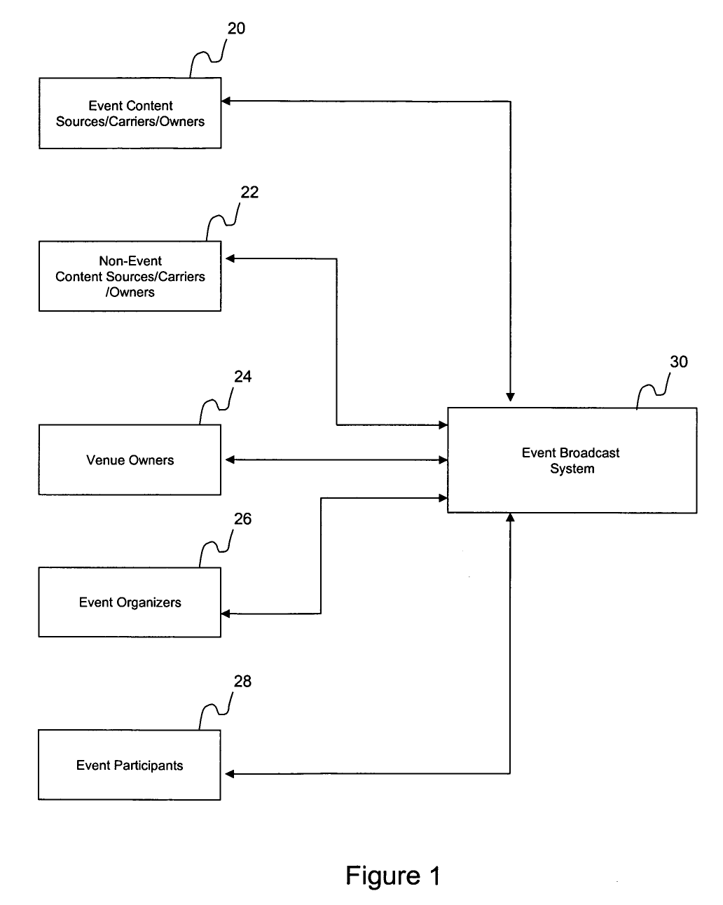

As shown in FIG. 1, various embodiments of the present invention provide for acquiring rights to receive and broadcast, including re-broadcast, content from a plurality of sources. Specifically, in order to provide various combinations of video and/or audio content for transmission at an event, the rights to the content, and more particularly, the rights to receive and transmit the signals defining the content are acquired from various sources (e.g., license payments to owners of the content). This may include acquiring rights to content from various venues (e.g., various stadium content, which may include the stadium content at the stadium where it is to be broadcast) and/or content carriers/owners (e.g., satellite carrier, cable carrier, over-the-air broadcast carrier, etc.). It should be noted that the carrier of the content may not be the owner of the content. Further, rights to allow access to the event and/or venue (e.g. payment to stadium owner) may be acquired from various sources (e.g., owner of a venue), for example, to allow transmission equipment (e.g., transmitter, antennas, etc.) and other production equipment to be located and transmit content at an event. It should be noted that rights to event (e.g., football game) may have to be acquired separate from rights to the venue (e.g., football stadium).

As shown in FIG. 1, rights to access and transmit (e.g., re-broadcast content) are acquired from a plurality of sources. The sources may include, but are not limited to, one or more event content sources/carriers/owners 20, non-event content sources/carriers/owners 22, venue owners 24, event organizers 26 and event participants 28. The rights allow access and transmission of content at an event using an event broadcast system 30. For example, for a football game, these sources may include the event organizer, namely, the National Football league; the event content sources/carriers/owners, namely, the network(s) carrying the event video/audio feeds (e.g., satellite provider, cable provider, etc.); the venue owner, namely, the owner of the stadium (e.g., to access feeds to in-stadium content); the event participants, namely, the owners of the teams participating in the game; the event related content sources/carriers/owners, namely, other sources/carriers/owners of content from other related events (e.g., feeds from other stadiums or sports broadcast by ESPN); and the non-event related content sources/carriers/owners, namely, the source/carriers/owners of non-event content (e.g., satellite broadcast of news). It should be noted that some content may be encompassed by more than one source. The event broadcast system 30 accesses the content (e.g., video and/or audio feeds) to which rights have been acquired and transmits some, all, or a combination of the content at an event.

Thus, various input sources for both event and non-event video and/or audio signals may be accessed and monitored, with specific content selected for broadcast by the broadcast system located at the event. This content may include, for example, video/audio of the event at which the system is located (e.g., different camera angles or views of the event), video/audio from different events (e.g., broadcast of a football game or race from another venue or location), and/or video/audio from other third parties (e.g., television broadcasts such as news, Internet content, prerecorded content, radio transmissions, etc.).

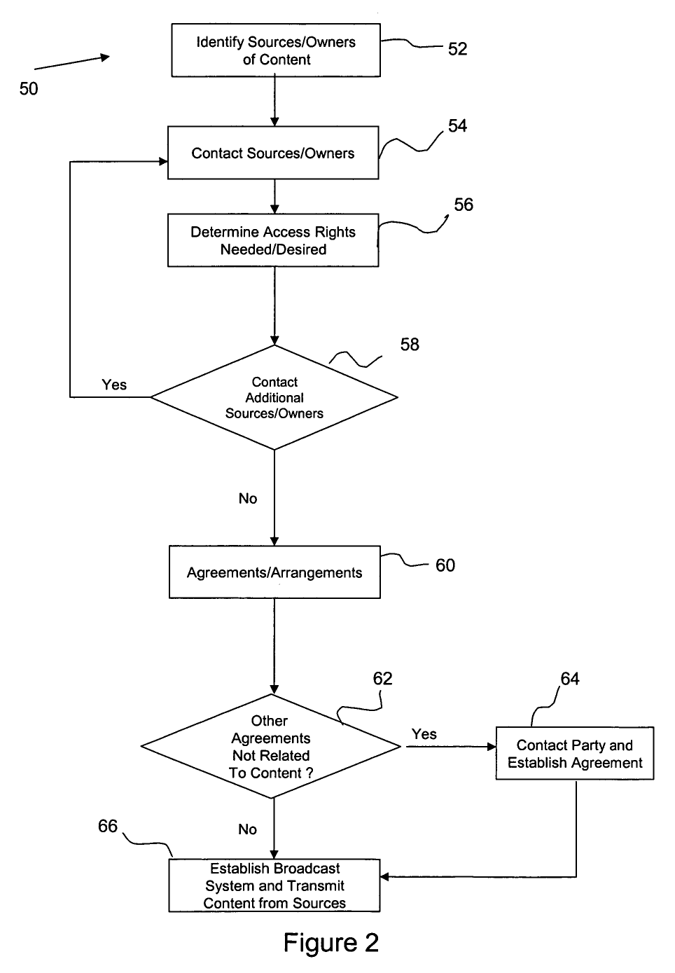

FIG. 2 is a flowchart 50 illustrating exemplary embodiments for acquiring rights to the content to be transmitted at the events. Specifically, at 52, sources and/or owners of content are identified. This may include identifying sources of content related to a particular event, a particular venue or other sources and/or owners of interest having content to be transmitted at an event. The identification of these sources and/or owners may be based upon, for example, the type of event, the location of the event, the type of venue, the type of spectators or participants at the event/venue, content ratings (e.g., television ratings), surveys, or some other criteria. In one exemplary embodiment, the sources are selected from those identified in FIG. 1. Once the sources and/or owners are identified, the sources and/or owners are contacted at 54 regarding the desired or needed content. A determination is then made at 56 as to the access rights needed and/or desired from the sources and/or owners. For example, a determination is made as to the specific audio/video feeds needed and/or access rights to equipment or event facilities (e.g., production facilities) that are needed.

A determination is the made at 58 as to whether additional sources and/or owners must be contacted in order to acquire the rights to the content. If additional sources and/or owners must be contacted, then the additionally identified sources and/or owners are contacted at 54. If no additional sources must be contacted, then at 60 agreements (e.g., license agreements) or other arrangements (e.g., right to use equipment at a stadium) are established. In particular, one or more agreements are established with one or more of the sources of the content. The agreements may have different durations and may be established at different times.

These agreements set forth the terms for accessing and transmitting at the event (e.g., re-broadcasting) the content from these sources. For example, an agreement may be established with the owner of a venue for payment of a lump sum fee, payment based on the number of viewers, payment based on advertising, and/or a combination thereof. An agreement may be established with the carrier of content, which may be event content, event related content from another event, non-event related content and/or non-event content, for payment of a lump sum fee, payment based on the amount or type of content to be re-broadcast, payment based on the number of channels actively selected for re-broadcast, and/or a combination thereof. Payment also may be varying based upon, for example, advertising revenues. An agreement may be established with the owner of the content for payment of a lump sum fee, payment based on the number of viewers currently accessing the content (e.g., accessing the content using portable devices at the event), payment based upon advertising revenue, and/or a combination thereof. It should be noted that the payments may be provided prior to accessing the content or over a period of use. Further, the payments may change based upon different factors as described herein. Generally, the duration and payment/fee arrangement may be determined based upon the parties involved.

At 62 a determination is then made as to whether additional rights need to be acquired for accessing and broadcasting the content at the event. For example, the owner of the event broadcast system 30 (shown in FIG. 1) may have to obtain a license from the Federal Communications Commission (FCC) to broadcast the content at the event. If the additional rights have to be acquired, then at 64 the party is contacted and an agreement established. In the FCC example, a designated individual approved by the FCC must approve the frequencies on which the content is to be broadcast. Thereafter, or if no additional rights need to be acquired, then the event broadcast system 30 is established for transmitting (e.g., re-broadcasting) content to one or more events from the sources from which the rights were acquired. This may include, for example, establishing permanent or temporary (e.g., production vehicle) communication links at one or more venues and/or events.

Systems for establishing these communication links and transmitting content at an event include, but are not limited to, the systems described in co-pending U.S. application entitled “System and Method for Providing Event Spectators With Audio/Video Signal Pertaining to Remote Events” filed Oct. 7, 2003 and having Ser. No. 10/680,612, and co-pending U.S. application entitled “System and Method for Providing Event Spectators with Audio/Video Signals from Different Sources” filed on Feb. 23, 2004 and having Ser. No. 60/546,901, the entire disclosures of which are hereby incorporated by reference herein. Additionally, the system for distributing audio and/or video signals described in U.S. Pat. No. 6,578,203, the entire disclosure of which is hereby incorporated by reference herein, may be used to establish the communication links and transmit content at the event.

Further, portable devices that may be used to receive this content may be any device having a receiver configured to receive signals from the various embodiments of the present invention described herein. For example, the portable device may be any suitable wireless device capable of displaying images or outputting sounds based on signals transmitted from the event broadcast system 30. These devices include, but are not limited to, laptop computers, electronic tablet devices, cellular telephones, personal digital assistants (PDAs) and/or other handheld portable devices having wireless capabilities. Further examples of these devices, include, but are not limited to, the devices described in co-pending U.S. application entitled “Electronic Handheld Audio/Video Receiver and Listening/Viewing Device” filed on Apr. 18, 2001 and having Ser. No. 09/837,128, the entire disclosure of which is hereby incorporated by reference herein; the devices described in co-pending U.S. application “Audio/Video System and Method Utilizing a Head Mounted Apparatus with Noise Attenuation” filed on Aug. 31, 1999 and having Ser. No. 09/386,613, the entire disclosure of which is hereby incorporated by reference herein; and the devices described in co-pending U.S. application entitled “Electronic Handheld Audio/Video Receiver and Listening/Viewing Device” filed on Jul. 30, 2003 and having Ser. No. 10/630,069, the entire disclosure of which is hereby incorporated by reference herein.

Thus, in operation, various embodiments of the present invention provide for acquiring rights from different sources to allow access to and transmission at an event of content from these sources. The plurality of sources may be related or unrelated to the event or venue, and may be located locally at the event or remote from the event.

It should be noted that the various embodiments may be modified as desired or needed. For example, the agreements established with the sources/carriers/owners of the content may be modified as desired or needed (e.g., based upon the event or venue).

While the invention has been described in terms of various specific embodiments, those skilled in the art will recognize that the invention can be practiced with modification.

1. A method for acquiring rights to content for transmission at an event, the method comprising:
identifying at least one of sources, carriers and owners of content for transmission at an event, the sources, carriers and owners including at least one of event content sources, event content carriers, event content owners, non-event content sources, non-event content carriers, non-event content owners, venue owners, event organizers and event participants;
determining access rights to be acquired to transmit the content at the event; and
establishing at least one agreement with at least one of the sources, carriers and owners to acquire the access rights to transmit the content at the event.

2. The method of claim 1, further comprising:
establishing separate agreements with the sources of the content, the carriers of the content and the owners of the content.

3. The method of claim 1, further comprising:
establishing a first agreement with an owner of a venue at which an event will occur; and
establishing a second agreement with a network carrying the event, the first and second agreements permitting replay of at least portions of the event live or time delayed.

4. The method of claim 1, further comprising:
establishing a first agreement with an owner of a venue at which an event will occur; and
establishing a second agreement with an event organizer, the first and second agreements permitting replay of at least portions of the event live or time delayed.

5. The method of claim 1, further comprising establishing a first agreement with a network carrying the event; and
establishing a second agreement with an event organizer, the first and second agreements permitting replay of at least portions of the event live or time delayed.

6. The method of claim 1, further comprising obtaining a government license to broadcast the content.

7. The method of claim 1, further comprising obtaining a government license to broadcast the content at the event.

8. The method of claim 1, further comprising establishing a first agreement with event participants; and
establishing a second agreement with an event organizer, the first and second agreements permitting replay of at least portions of the event live or time delayed.

9. The method of claim 1, wherein the agreements allow access to, and transmission of, content at an event, the content relating to the event.

10. A method for acquiring rights to content for transmission at an event, the method comprising:
identifying at least one of sources, carriers and owners of content for transmission at an event, the sources, carriers and owners including at least one of event content sources, event content carriers, event content owners, non-event content sources, non-event content carriers, non-event content owners, venue owners, event organizers and event participants;
determining access rights to be acquired to transmit the content at the event;
establishing a first agreement with an owner of a venue, at which an event will occur; and
establishing a second agreement with a network carrying the event, the first and second agreements permitting replay of at least portions of the event live or time delayed.

11. The method of claim 10, further comprising establishing a third agreement with an event organizer, the first, second and third agreements permitting replay of at least portions of the event live or time delayed.

12. The method of claim 10, further comprising establishing a third agreement with an event organizer, the first, second and third agreements permitting replay of at least portions of the event live or time delayed.

13. The method of claim 10, further comprising obtaining a government license to broadcast the content.

14. The method of claim 10, further comprising obtaining a government license to broadcast the content at the event.

15. The method of claim 10, further comprising establishing a third agreement with event participants; and
establishing a first agreement with an event organizer, the first, second, third and fourth agreements permitting replay of at least portions of the event live or time delayed.

16. A method for acquiring rights to content for transmission at an event, the method comprising:
identifying at least one of sources, carriers and owners of content for transmission at an event, the sources, carriers and owners including at least one of event content sources, event content carriers, event content owners, non-event content sources, non-event content carriers, non-event content owners, venue owners, event organizers and event participants;
determining access rights to be acquired to transmit the content at the event;
establishing a first agreement with at least one of the sources, carriers and owners to acquire the access rights to transmit the content at the event;
establishing a second agreement with an event organizer; and
wherein the agreements allow access to, and transmission of, content at an event, the content relating to the event.

17. The method of claim 16, further comprising:
establishing the first agreement with the owner of the venue at which an event will occur; and
establishing a third agreement with the network carrying the event, the first and second agreements permitting replay of at least portions of the event live or time delayed.

18. The method of claim 16, further comprising obtaining a government license to broadcast the content.

19. The method of claim 16, further comprising obtaining a government license to broadcast the content at the event.

20. The method of claim 16, further comprising establishing a third agreement with event participants, the first, second and third agreements permitting replay of at least portions of the event live or time delayed.
